(19) United States
(12) Patent Application Publication
(10) Pub. No.: US 2007/0143294 A1
(43) Pub. Date: Jun. 21, 2007

(54) Network information access system

(75) Inventor: I-Ru Liu, Taipei City (TW)

Correspondence Address: BIRCH STEWART KOLASCH & BIRCH, PO BOX 747, FALLS CHURCH, VA, 22040-0747, US

(73) Assignee: ACCTON TECHNOLOGY CORPORATION

(21) Appl. No.: 11/300,330

(22) Filed: Dec. 15, 2005

(51) Int. Cl. G06F 17/30

(52) U.S. Cl. 707/10

(57) ABSTRACT

A network information access system includes a track, an access point, a sensor, a server, and a power supply. The access point generates at least one loading status signal and has a driving unit and a rolling unit. In this case, the rolling unit is connected to the driving unit and the track. The sensor is located adjacent to the track to sense a position of the access point on the track. The server controls the access point moved along the track in accordance with the loading status signal. The power supply provides at least one power source into the access point, the sensor, and the server.

### BACKGROUND OF THE INVENTION

1. Field of Invention

The invention relates to a network information access system and, in particular, to a movable network information access system.

2. Related Art

Recently, the rapidly developed network technique not only speeds the transmission of various information around the world but also makes our life more plentiful. People can forward e-mails, transmit data files, view Bulletin Board System (BBS), or remotely access systems through the network. This may influence the work style of governments and enterprises, and vary our life.

An electrical device or an electrical apparatus uses a network line to connect to a conventional wired access point for accessing the network resources. In this case, the arrangement of the network line may trouble the user, and the user may not use the network resources with the fixed network line when he or she is moving.

Accompanying with the development of wireless technology, some manufacturers disclosed the access point (AP) to reduce the peripheral lines. Therefore, the electrical device or the electrical apparatus can access the network resources when it is arbitrarily moved.

However, the conventional access point usually has a fixed arrangement. In more detailed, if an access point is provided in an office, the user may use the network resources within the area covered by the signal of the access point. However, if the user leaves this area, the network resources are no longer available. In addition, if the number of the users exceeds what the access point can support, some users may not access the network resources successfully.

It is therefore an important subject of the invention to provide a network information access system for the user to access the network at arbitrarily position such as the supermarket, the department store, the basketball court or the baseball field in cooperation with the developed wireless fidelity (Wi-Fi) technology.

### SUMMARY OF THE INVENTION

In view of the foregoing, the invention is to provide a movable network information access system.

To achieve the above, a network information access system of the invention includes a track, an access point, a sensor, a server, and a power supply. The access point generates at least one loading status signal and has a driving unit and a rolling unit. In this case, the rolling unit is connected to the driving unit and the track. The sensor is located adjacent to the track to sense a position of the access point on the track. The server controls the access point moved along the track in accordance with the loading status signal. The power supply provides at least one power into the access point, the sensor, and the server.

As mentioned above, the network information access system of the invention connects the access point to the track and generates the loading status signal to the server by the access point, so that the server can control the access point moving along the track to satisfy the requirement of the user for arbitrarily using the network resources.

In addition, the invention also discloses a network information access system including a track, a plurality of access points, at least a sensor, a server, and a power supply. The access points generate at least one loading status signal respectively, and each of the access points has a driving unit and a rolling unit. In this case, the rolling unit is connected to the driving unit and the track. The sensor is located adjacent to the track to sense a position of each of the access points on the track. The server controls the access points moved along the track in accordance with the loading status signal. The power supply provides at least one power into the access point, the sensor, and the server.

As mentioned above, the network information access system of the invention connects the access points to the track and generates the loading status signal to the server by each of the access points, so that the server can control the access points moving along the track to satisfy the requirements of the user for arbitrarily using the network resources.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a network information access system according to an embodiment of the invention;

FIG. 2A and FIG. 2B are schematic diagrams showing the configuration of the network information access system according to the embodiment of the invention, wherein FIG. 2A shows the access point disposed on a linear track, and FIG. 2B shows the access point disposed on a loop track;

FIG. 3A and FIG. 3B are schematic diagrams showing the different configurations of the network information access system according to the embodiment of the invention; and

FIG. 4 is a schematic diagram showing the operating status of the access points according to the embodiment of the invention.

FIG. 5A is a schematic diagram showing a linear track configuration of the network information access system with sleep mode access point.

FIG. 5B is a schematic diagram showing a loop track configuration of the network information access system with sleep mode access point.

### DETAILED DESCRIPTION OF THE INVENTION

A network information access system of the invention will be apparent from the following detailed description, which proceeds with reference to the accompanying drawings, wherein the same references relate to the same elements.

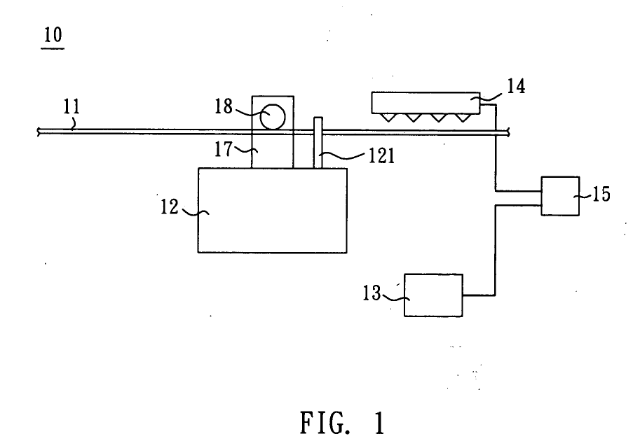

Referring to FIG. 1, which is a schematic diagram showing the network information access system according to an embodiment of the invention. As shown in FIG. 1, the network information access system 10 includes a track 11, an access point 12, a server 13, a sensor 14, and a power supply 15.

The access point 12 is connected to the track 11 and can be moved along the track 11. In the embodiment, the access point has a driving unit 17 connected to the access point 12 and a roller unit 18 connected to the driving unit 17 and the track 11. The access point 12 moves along the track 11 with the roller unit 18 driven by the driving unit 17. The driving unit 17 may include a gear component and/or a direct current (DC) motor. The access point 12 provides a bipolar bias to the DC motor for driving the roller 18, so that a moving direction of the access point 12 along the track 11 can be controlled. In addition, the driving unit 17 also can brake the access point 12.

The server 13 is used to control the access point to move along the track 11. In the embodiment, the server 13 controls the access point 12 to provide the bipolar bias to the driving unit 17 by way of wireless transmission. Accordingly, the access point 12 can move along the track 11.

The sensor 14 is located adjacent to the track 11 and used to sense a position of the access point 12 on the track 11. The sensor 14 can be a contact sensor or a proximity sensor. In the embodiment, the sensor 14 delivers a signal to the server 13 as sensing the position of the access point 12, and then the server 13 can monitor the position of the access point 12 in accordance with the signal. In addition, in the embodiment, the sensor 14 is a contact sensor. When a contact element 121 disposed on the access point 12 touches the contact sensor 14, the sensor 14 delivers the signal to the server 13.

The power supply 15 provides a power source for the network information access system 10. In the embodiment, the power supply 15 provides the power source to the access point 12, the server 13, and the sensor 14 respectively for driving them. The power source can be provided to each of the access point 12, the server 13, and the sensor 14 through a power cord. Besides, the power source can be provided to each of the access point 12, the server 13, and the sensor 14 through the track 11. In other words, the power supply 15 provides the power source to the track 11 and the access point 12 moving along the track 11 receives the power source from the track 11. Therefore, the wire arrangement of the network information access system can be simplified.

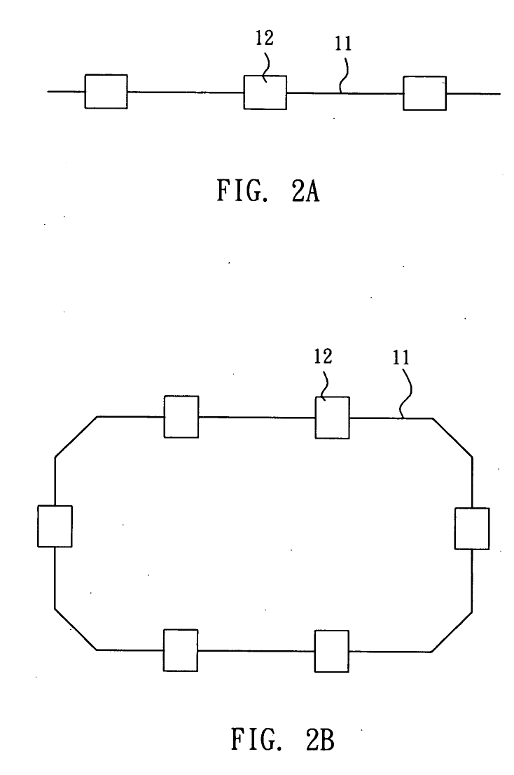

In the embodiment, a plurality of access points 12 can be disposed on the track 11, wherein each service set identifier (SSID) of the access points are the same. In addition, at least one of the access points 12 can be operated at a first frequency and another one of the access points 12 can be operated at a second frequency to apply in various occasions such as an office, a department store, or a gym. Furthermore, the track 11 can be varied into different type according to practical demands for various occasions. Referring to FIG. 2A to FIG. 2C showing the configuration of the track 11 and access points 12, the track 11 may be a linear track (as shown in FIG. 2A) or a loop track (as shown in FIG. 2B).

To make the invention more comprehensive, the network information access system having a plurality of access points 12 dispose on the track 11 will be described hereinafter.

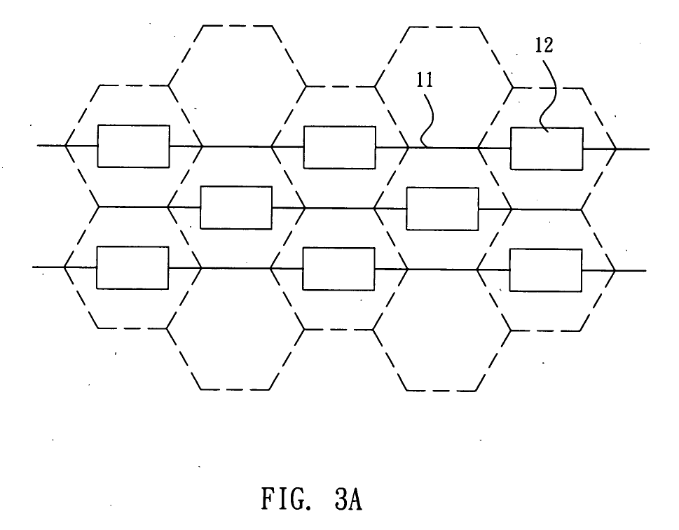

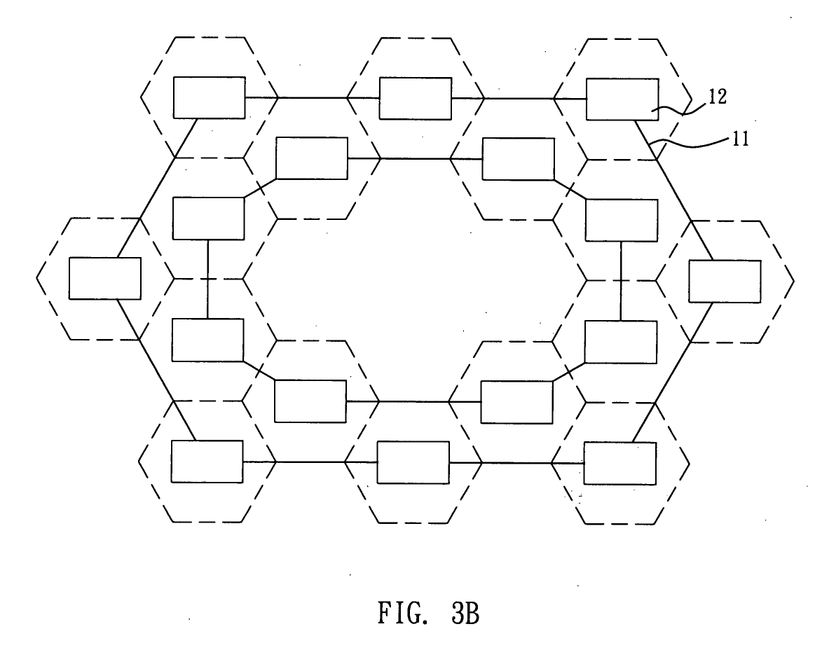

Referring to FIG. 3A and FIG. 3B, when the network information access system 10 has a plurality of linear tracks or loop tracks, the access points 12 disposed on the track 11 are in a honeycombed arrangement for providing a better signal covering range.

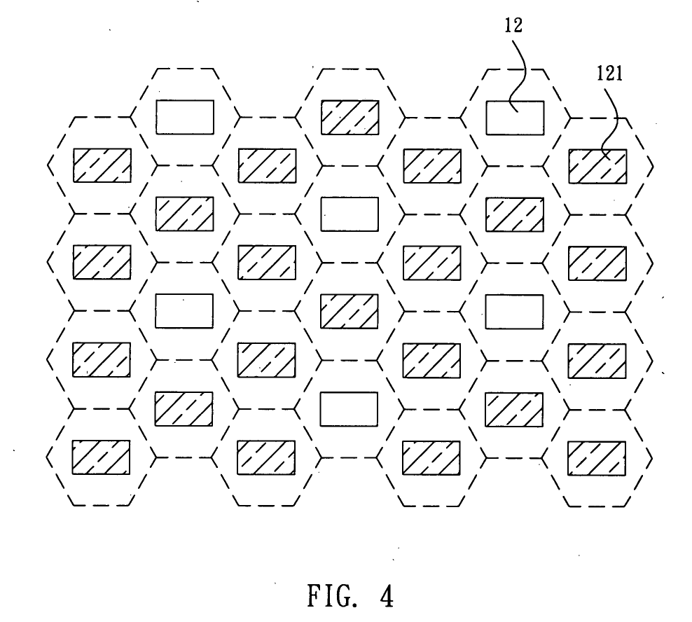

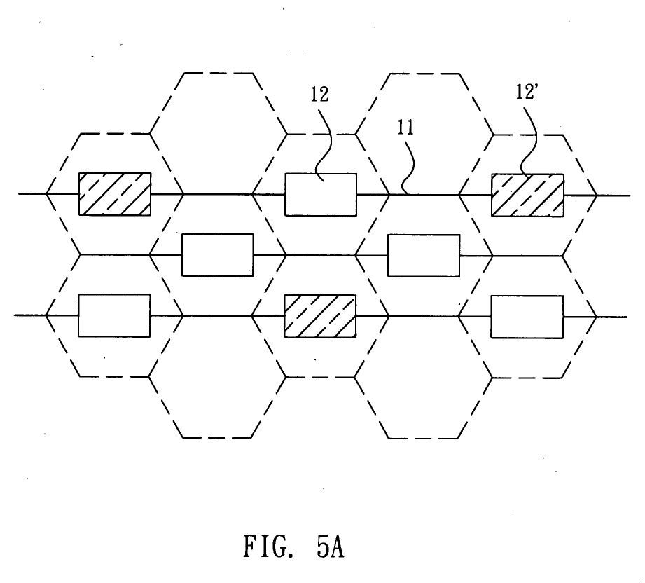

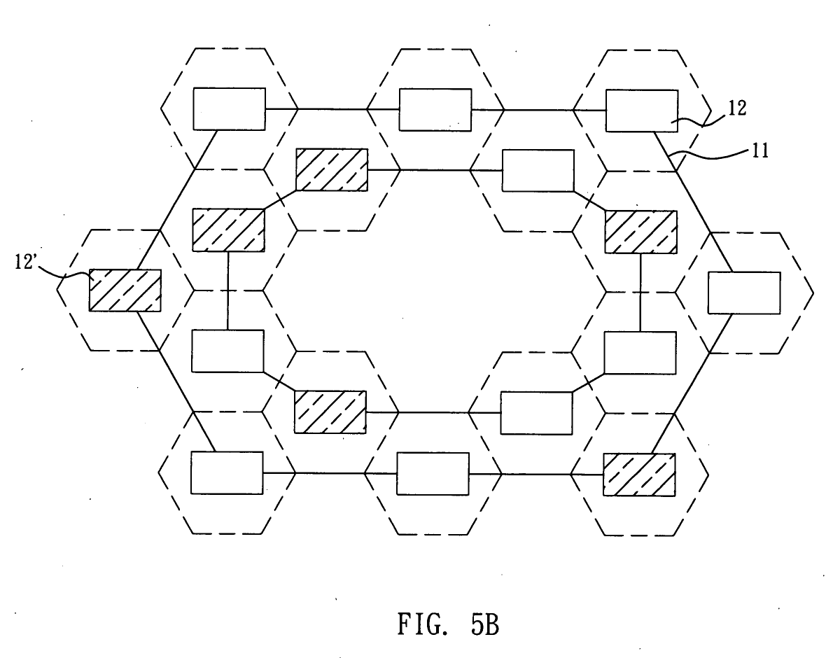

In the embodiment, the server 13 can further control the operating statuses of the access points 12. Referring to FIG. 4, the server 13 controls the operating status of at least one of the access points 12′ to be a sleep mode. FIG. 5A and FIG. 5B are showing the configuration of the network information access system with the sleep mode AP 12′ disposed on the linear track and loop track respectively. In this case, the server 13 can set the operating statuses of some access points 12 to be the sleep mode when the number of the users is fewer. In addition, the server 13 also can control the operating frequencies or channels of each access points 12 or 12′ to apply with more condition. Thus, the power consumption can be efficiently reduced.

More details, the network information access system 10 of the invention is to measure at least one monitoring signal parameter that a signal coverage by the access points 12, and to transform the monitoring signal parameter into a loading status parameter. Then, the access points 12 is to generate a loading status signal after comparing the monitoring signal parameter with the loading status parameter. In this case, the monitoring signal parameter comprises a signal quality parameter, a link quality parameter, or a quality of service parameter and the default parameter comprises a loading distribution parameter, a peak signal parameter, a priority parameter, or a response timing parameter. The server 13 is to check the loading status of each access points such as the high loading status, the low loading status, or the normal loading status in accordance with the loading status signal for representing the corresponding user density, such as a high user density, a low user density or a normal user density, within the area where each access point 12 is located.

For example, the server 13 checks each access point 12 is located at a high user density area, a low user density area or a normal user density in accordance with a loading status sent from each access point 12.

If the access point 12 works at the high user density area, the server 13 drives at least one access point 12 to move from other area to the high user density area, so that the loading of the access points 12 located in the high user density area can be shared and thus reduced. And then, the server 13 adjusts down the output power of the access points 12 located in the high user density area for adjusting the loading status of each access point 12. Alternatively, the server 13 can activate access points 12 of the sleep mode to adjust the loading status of each access point 12.

If the access point 12 works at the low user density area, the server 13 drives the access points 12 to move from the low user density area to other area. And then, the server 13 adjust up the output power of the access points 12 located in the low user density area for adjusting the loading status of each access point 12. Alternatively, the server 13 can control the operating status of a part of the access points 12 to be the sleep mode for adjusting the loading status of each access point 12.

If the access point 12 works at the normal user density area, each of the access points 12 sends its loading status to the server 13, so that the server 13 can control the configurations of the access points 12 moving along the track 11.

The AP not only can be controlled by the loading status but also can be controlled by the manual or other parameters so that the network information access system can be applied with the various conditions or occasions. The parameter such as a distribution of the load is average or not, a condition of peak load is being at one of the area or not, a high service priority user is in the area or not, or a response time of the system demanded.

In summary, the network information access system of the invention disposes the access point on the track, so that the access point can move along the track. Cooperation with the control of the server, the access point can be moved to a suitable position in accordance with the positions and the density of users. Thus, the requirements of the user for arbitrarily using the network resources can be satisfied. In addition, the operating statuses of the unnecessary access points can be set as the sleep mode to reduce the power consumption. Therefore, the network information access system can be successfully applied in Wi-Fi, so that the user can arbitrarily use network resources at the place of the department store, the gym, and the likes.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network information access system, comprising:
a track;
an access point generating at least a loading status signal and having a driving unit and a rolling unit, wherein the rolling unit is connected to the driving unit and the track;
a sensor located adjacent to the track and sensing a position of the access point on the track;
a server controlling the access point moved along the track in accordance with the loading status signal; and
a power supply providing at least a power source to the access point, the sensor, and the server.

2. The system according to claim 1, wherein the track is a linear track or a loop track.

3. The system according to claim 1, wherein the sensor is a contact sensor or a proximity sensor.

4. The system according to claim 1, wherein the driving unit is a gear component.

5. The system according to claim 1, wherein the driving unit is a direct current (DC) motor.

6. The system according to claim 5, wherein the access point provides a bipolar bias for the DC motor to control a moving direction of the access point.

7. A network information system, comprising:
a track;
a plurality of access points generating at least a loading status signal respectively and each of the access points having a driving unit and a rolling unit, wherein the rolling unit is connected to the driving unit and the track;
at least a sensor located adjacent to the track and sensing a position of each of the access points on the track;
a server controlling the access points moved along the track in accordance with the loading status signal; and
a power supply providing at least a power source to the access points, the sensor, and the server.

8. The system according to claim 7, wherein the rolling unit of each access points is slid on the track and moved along the track.

9. The system according to claim 7, wherein the track is a linear track or a loop track.

10. The system according to claim 7, wherein the sensor is a contact sensor or a proximity sensor.

11. The system according to claim 7, wherein the driving unit is a gear component.

12. The system according to claim 7, wherein the driving unit is a direct current (DC) motor.

13. The system according to claim 12, wherein each of the access points provides a bipolar bias for the DC motor to control a moving direction of each of the access points.

14. The system according to claim 7, wherein an operating status of at least one of the access points is a sleep mode.

15. The system according to claim 7, wherein the server controlling the access points to move along the track.

16. The system according to claim 7, wherein an arrangement of the access points is honeycombed.

17. The system according to claim 7, wherein at least one of the access points is operated at a first frequency and another one of the access points is operated at a second frequency.
